(19) United States
(12) Patent Application Publication
(10) Pub. No.: US 2007/0006562 A1
(43) Pub. Date: Jan. 11, 2007

(54) Spindle assembly and lawn mower cutting deck incorporating same

(76) Inventors: Benjamin P. Davis, Beatrice, NE (US); Garry W. Busboom, Beatrice, NE (US)

Correspondence Address: MUETING, RAASCH & GEBHARDT, P.A., P.O. BOX 581415, MINNEAPOLIS, MN, 55458, US

(21) Appl. No.: 10/943,800

(22) Filed: Sep. 17, 2004

(51) Int. Cl. A01D 34/00

(52) U.S. Cl. 56/17.5

(57) ABSTRACT

A mower blade driver spindle assembly and cutting deck incorporating the same. The spindle assembly may include a spindle shaft having a first end and a first anti-rotate surface, e.g., a female spline, at or near the first end. A bushing may be included that provides a second anti-rotate surface, e.g., a male spline, for engaging the first anti-rotate surface such that little or no relative rotation occurs between the bushing and the spindle shaft. The bushing may also include a flange for holding the cutting blade against the first end of the spindle shaft.

### TECHNICAL FIELD

The present invention relates to spindle assemblies and methods of using the same, and, more specifically, to mower blade driver spindle assemblies and lawn mower cutting decks incorporating the same.

### BACKGROUND

Lawn mowers utilizing one or more rotatable cutting blades rotationally coupled to a cutting deck are known. The blades are, when selectively energized, generally operable to cut grass and other vegetation over which the cutting deck passes.

With multiple-blade decks, such as those found on most wide area (riding and walk-behind) mowers, each cutting blade is typically attached to a lower end of a vertically-oriented spindle shaft passing through a housing of the cutting deck. The spindle shaft may be supported by bearings contained within a spindle housing, which is, in turn, coupled to the deck housing. An upper end of the spindle shaft, which protrudes above an upper surface of the deck housing, may have attached thereto a driven sheave. In operation, an engine powers a drive belt that provides power to the driven sheave. The rotating sheave, in turn, rotates the spindle shaft and, as a result, the cutting blade.

Many single and multiple-blade lawn mowers are configured such that each cutting blade is attached to its respective spindle shaft with a threaded blade attachment fastener that passes through the blade and engages a threaded hole in the lower end of the spindle shaft. The blade may be detached from the mower by loosening and removing the attachment fastener.

While effective, these spindle configurations have drawbacks. For example, when a cutting blade attached in this manner is quickly slowed or stopped (such as may occur when the blade strikes undulating ground or objects/debris such as fallen limbs, rocks, etc.), inadvertent over-tightening of the attachment fastener may occur. This over-tightening may result from continued rotation of the spindle shaft relative to the slowed (or stalled) attachment fastener and cutting blade. Such over-tightening is undesirable as it may increase the level of difficulty associated with blade removal, an activity that may occur frequently in some commercial applications. In severe instances, the threads of the attachment fastener and/or the spindle shaft may be stripped or otherwise damaged by this over-tightening.

### SUMMARY

Apparatus and methods of the present invention may overcome these and other problems associated with conventional spindle configurations. For example, in one embodiment, a spindle assembly for supporting a cutting blade in relation to a lawn mower cutting deck is provided. The assembly includes a spindle shaft having a first end with an opening formed therein, the opening including a female anti-rotate surface. A tubular bushing is also provided and includes: a male anti-rotate surface for engaging the female anti-rotate surface such that little or no relative rotation occurs between the bushing and the spindle shaft; and a flange for holding the cutting blade against the first end of the spindle shaft.

In another embodiment, a lawn mower cutting deck is provided and includes: a deck housing defining a cutting chamber; a cutting blade operable to rotate within the cutting chamber; and a spindle assembly for rotationally coupling the cutting blade to the housing. The spindle assembly includes a spindle shaft having a first end proximate a first side of the cutting blade, wherein an opening is formed in the first end, the opening including a plurality of first splines therein. A bushing having a flange and a plurality of second splines is further provided. The second splines are operable to engage the first splines such that little or no relative rotation occurs between the bushing and the spindle shaft. The cutting blade is located between the flange of the bushing and the first end of the spindle shaft.

In yet another embodiment, a lawn mower cutting deck is provided with a spindle assembly that includes: a spindle shaft having a first anti-rotate surface located within an opening formed at a first end of the spindle shaft; and a bushing having a second anti-rotate surface and a flange. The second anti-rotate surface is operable to engage the first anti-rotate surface such that little or no relative rotation occurs between the bushing and the spindle shaft. A cutting blade securable between the flange of the bushing and the first end of the spindle shaft is further provided, as is a housing for rotationally supporting the spindle assembly.

In still yet another embodiment, a lawn mower cutting deck is provided. The deck includes a deck housing defining a cutting chamber; a cutting blade operable to rotate within the cutting chamber; and a spindle shaft for rotationally attaching the cutting blade to the housing. The spindle shaft includes: a first end having an opening formed therein, wherein the first end is operable to abut a first side of the cutting blade; and two or more first splines located on an interior surface of the opening. A tubular bushing is also provided and includes: two or more second splines located on an exterior surface of the bushing, the second splines operable to pass, with clearance, through a hole in the cutting blade and engage the first splines; and a flanged portion operable to abut a second side of the cutting blade. A fastener is provided for securing the bushing and the cutting blade to the spindle shaft.

In another embodiment, a method for preventing over-tightening of a cutting blade attachment fastener relative to a lawn mower spindle shaft as a result of a blade strike is provided. The method includes: inserting a flanged bushing through an opening in a cutting blade; engaging a male anti-rotate surface of the flanged bushing with a female anti-rotate surface of the spindle shaft; and fastening the flanged bushing to the spindle shaft with a bolt.

The above summary of the invention is not intended to describe each embodiment or every implementation of the present invention. Rather, a more complete understanding of the invention will become apparent and appreciated by reference to the following detailed description and claims in view of the accompanying drawing.

### BRIEF DESCRIPTION OF THE VIEWS OF THE DRAWING

The present invention will be further described with reference to the figures of the drawing, wherein:

FIG. 1 is a perspective view of an underside of a vehicle, e.g., a riding lawn mower, incorporating a cutting deck having multiple mower blade driver spindle assemblies in accordance with one embodiment of the present invention;

FIG. 2 is a partial cross-section view of the spindle assembly and cutting blade of FIG. 1;

FIG. 3 is an exploded perspective view of the spindle assembly and cutting blade of FIG. 1; and

FIG. 4 is a section view taken along line 4-4 of FIG. 2.

### DETAILED DESCRIPTION OF EXEMPLARY EMBODIMENTS

In the following detailed description of exemplary embodiments, reference is made to the accompanying views of the drawing which form a part hereof, and in which are shown by way of illustration specific embodiments in which the invention may be practiced. It is to be understood that other embodiments may be utilized and structural changes may be made without departing from the scope of the present invention.

Generally speaking, embodiments of the invention described herein are directed to spindle assemblies operable to support an operating member, e.g., a lawn mower cutting blade. In the examples herein, the invention is illustrated and described in the context of blade driver spindle assemblies and lawn mower cutting decks incorporating the same. Such blade driver spindle assemblies may be rotationally attached to a cutting deck housing such that they may transmit power from a power source, e.g., from an engine, to a cutting blade attached (typically via a blade attachment fastener) to a spindle shaft of the assembly. In one embodiment, power may be transmitted by a belt coupled between a drive sheave of the engine and a driven sheave of the spindle assembly (see e.g., U.S. Pat. No. 6,651,413 (Papke), which is incorporated herein by reference in its entirety).

Under some circumstances, embodiments of the present invention may permit rotation of the cutting blade relative to the spindle shaft and the blade attachment fastener. By allowing such relative motion, inadvertent over-tightening of the blade attachment fastener may be avoided during, for example, blade strikes.

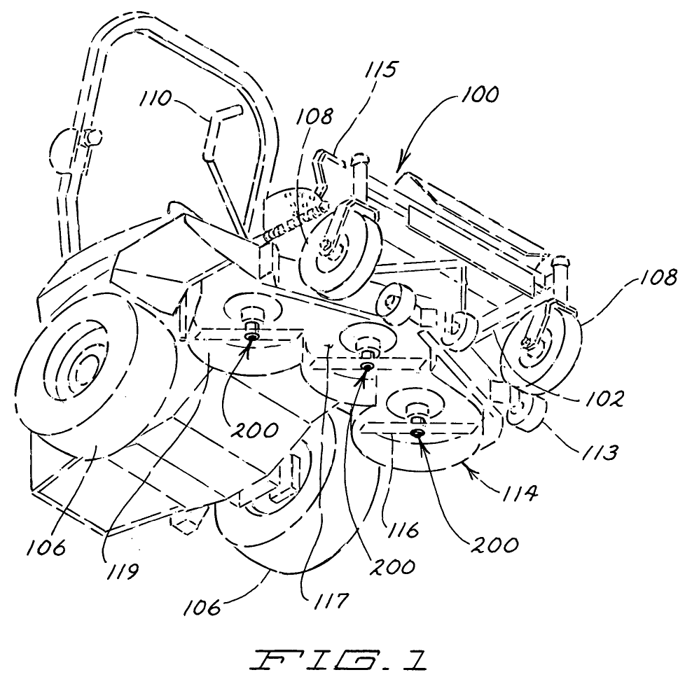

FIG. 1 illustrates a blade driver spindle assembly 200 in accordance with one embodiment of the present invention as it may be incorporated on a cutting deck of a self-propelled, ground maintenance vehicle, e.g., a zero-radius-turning (ZRT) riding lawn mower 100 (also referred to herein simply as a “mower”). The illustrated embodiment is a three-spindle configuration. However, this is not limiting as cutting decks incorporating most any number of spindles are contemplated. Moreover, while the invention is herein described with respect to a riding mower, those of skill in the art will realize that the invention is equally applicable to other types of mowers (e.g., towed, walk-behind, etc.) as well as to most any other type of spindle assembly.

The general mower configuration, although not necessarily central to the invention, is now briefly described. FIG. 1 clearly illustrates the mower 100 having a frame 102 supporting a prime mover, e.g., internal combustion engine (not shown). Left and a right ground engaging drive wheels 106 may be rotatably coupled to left and right sides of a rear portion of the mower 100. The drive wheels 106 may be independently powered by the engine (e.g., via one or more hydraulic motors, transmissions, or the equivalent) so that the drive wheels 106 may propel the mower 100 over a ground surface during operation.

One or more controls, e.g., left and right drive control levers 110 (only right lever shown) may also be provided. The drive control levers 110 are generally pivotally coupled to the mower such that they may pivot forwardly and rearwardly under the control of an operator sitting in an operator's seat (not shown). The drive control levers 110 are operable to independently control speed and direction of the respective drive wheels 106 via manipulation of the mower's drive system as is known in the art. For example, incremental forward movement (e.g., pivoting about a transverse horizontal axis) of the left (or right) drive control lever 110 (from a neutral position) results in an incremental increase in rotational speed of the left (or right) drive wheel 106 in a forward direction. Similarly, incremental rearward movement of the left (or right) drive control lever 110 (from a neutral position) results in an incremental increase in rotational speed of the left (or right) drive wheel 106 in a rearward direction.

While illustrated herein as incorporating separate drive control levers 110, other controls, e.g., single or multiple joysticks or joystick-type levers, may also be used without departing from the scope of the invention.

A pair of front swiveling caster wheels 108 may support a front portion of the mower 100 in rolling engagement with the ground surface. Although the illustrated mower has the drive wheels 106 in the rear and the caster wheels 108 in front, this configuration is not limiting. For example, other embodiments may reverse the location of the wheels, e.g., drive wheels in front and caster wheels in back. Moreover, other configurations may use different wheel configurations altogether, e.g., a tri-wheel configuration. Other mower configuration are certainly possible without departing from the scope of the invention.

A mower cutting deck 114 may be mounted to the lower side of the frame 102, e.g., generally between the drive wheels 106 and the caster wheels 108. The cutting deck 114 may include a deck housing 117 that defines a cutting chamber 119. The cutting chamber 119 may partially surround one or more rotatable cutting blades 116 each attached to a spindle assembly 200.

During operation, power is selectively delivered to the cutting deck 114 (e.g., to the spindle assemblies 200) and the drive wheels 106, whereby the cutting blades 116 rotate at a speed sufficient to sever grass and other vegetation as the deck passes over the ground surface. Typically, the cutting deck 114 has an operator-selectable height-of-cut control 115 to allow height adjustment relative to the ground surface. The cutting deck 114 may optionally include deck rollers 113 to assist in supporting the deck relative to the ground surface. Other miscellaneous controls may also be included to permit operator control of specific mower functions, e.g., throttle, blade engagement, etc.

Other aspects/features of the mower 100, e.g., those that are either not central to the invention or are readily known by those skilled in the art, may also be included. However, such other aspects/features are not further discussed and/or illustrated herein.

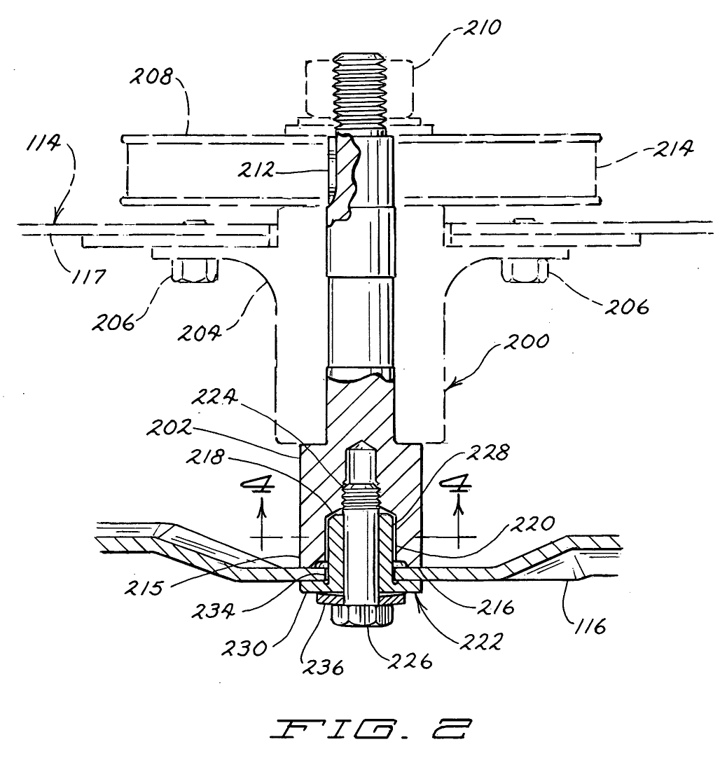

FIG. 2 is a partial section view of the exemplary spindle assembly 200 of FIG. 1. As illustrated in this view, the spindle assembly 200 may include a spindle shaft 202 that rotates within a spindle housing 204 attached (e.g., with fasteners 206) to the deck housing 117. The spindle housing 204 may include bearings (not shown) to permit rotation of the spindle shaft 202 relative to the spindle housing.

The spindle shaft 202 may include a first end 215 extending towards the ground surface. The first end 215 may form a face 216 that, in the illustrated embodiment, abuts the cutting blade 116. The spindle shaft 202 may further include an opening 218 formed proximate the first end 215 and normal to the face 216. The opening 218 may include a first portion 220 operable to receive an anti-rotate bushing 222 as further described below, and a second threaded portion 224 operable to threadably receive the blade attachment fastener, e.g., threaded bolt 226.

A driven sheave 208 may be attached to an opposing second end of the spindle shaft 202 and secured thereto, e.g., with a nut 210. A drive connection, e.g., a key/keyway 212, may permit transmission of rotational power from a drive belt 214 to the spindle shaft 202 for driving the cutting blade 116.

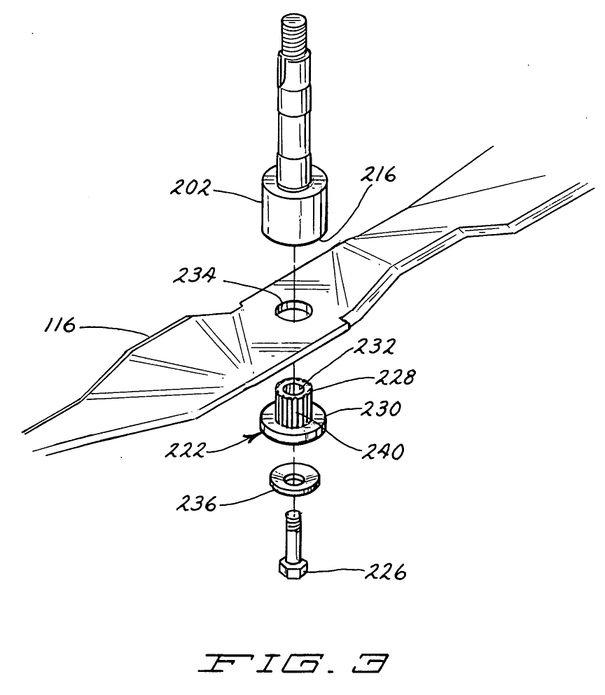

FIG. 3 is an exploded view of a portion of the spindle assembly 200 of FIG. 1. In this view, the exemplary anti-rotate bushing 222 is clearly illustrated as having a shaft engagement or anti-rotate portion 228, and a flange or flange portion 230. In the illustrated embodiment, the bushing 222 is tubular, i.e., the bushing has a through-hole 232. The through-hole 232 may be sized to provide clearance for the bolt 226 to pass through the bushing 222 as illustrated in FIG. 2. While the bushing 222 is illustrated as generally cylindrical in shape, this is not limiting and most any shape is possible without departing from the scope of the invention.

The anti-rotate portion 228 of the bushing 222 may have an effective outer (external) dimension, e.g., diameter, that is less than a diameter of a hole 234 in the cutting blade 116. Thus, the anti-rotate portion 228 of the bushing 222 may pass through the blade 116 with clearance and engage the opening 218 in the face 216 of the spindle shaft 202 as shown in FIG. 2. The flange portion 230, on the other hand, may have an effective outer (external) dimension, e.g., diameter, that is greater than the diameter of the hole 234 such that the cutting blade 116 may be clamped between a clamp surface of the flange portion and the first end 215 of the spindle shaft 202 (see FIG. 2). Optionally, a washer 236 may be provided between the flange portion 230 and a head of the bolt 226.

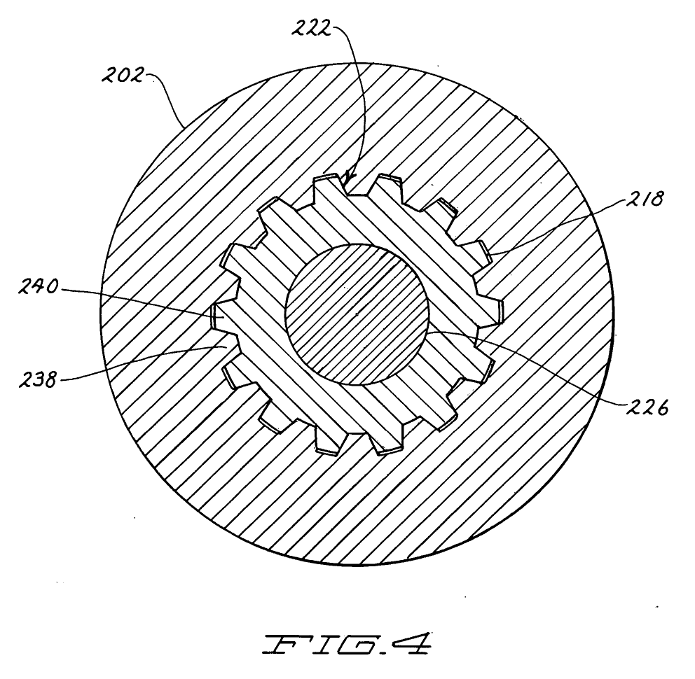

The first portion 220 of the opening 218 (see, e.g., FIGS. 2 and 4) may include one or more (e.g., two or more) first or female anti-rotate surfaces. In the illustrated embodiment, a series of first anti-rotate surfaces may be provided proximate the first end 215 of the spindle shaft 202 (e.g., on an inner surface of the opening 218). The first anti-rotate surfaces may be in the form of longitudinal first splines 238 located on an interior surface of the opening 218. The first splines are visible, for example, in FIG. 4. The first splines 238 may engage one or more second or male anti-rotate surfaces associated with the bushing 222. The second anti-rotate surfaces may include mating, longitudinal second splines 240 located on an exterior surface of the bushing 222 as shown, for example, in FIGS. 3 and 4. The splines 238 and 240 may, when the bushing 222 is attached to the spindle shaft 202, engage one another such that little or no relative rotation occurs between the spindle shaft and the bushing (some minimal movement may occur due to manufacturing tolerances and assembly requirements).

To assemble the spindle assembly, the anti-rotate portion 228 of the bushing 222 may be inserted through the hole 234 of the cutting blade and into the opening 218 of the spindle shaft 202. The bushing 222 may be inserted until the flange portion 230 abuts one side of the cutting blade 116 and the face 216 of the spindle shaft 202 abuts an opposite (e.g., upper) side of the cutting blade. As the bushing 222 is inserted into the opening 218, the second splines 240 of the bushing may engage the first splines 238 of the spindle shaft. As a result, the bushing 222 may be substantially fixed rotationally relative to the spindle shaft 202.

The bolt 226 may then pass through the through-hole 232 of the bushing 222 (as well through as the optional washer 236), engage the second threaded portion 224 of the opening 218, and tightened appropriately. As a result, the cutting blade 116 may be rotationally secured, relative to the spindle shaft 202, by friction resulting from a clamp force imparted by the bolt 226. The clamp force may be applied between the flange portion 230 of the bushing 222 and the face 216 of the spindle shaft 202.

While the cutting blade 116 is illustrated as directly abutting both the first end of the spindle shaft 202 and the flange portion 230, other embodiments may utilize an intermediate member, e.g., a spacer, at one or both interfaces without departing from the scope of the invention.

During operation of the cutting deck 114, power may be delivered, e.g., via the belt 214 and sheave 208 (see FIG. 2), to the spindle shaft 202. Rotation of the spindle shaft 202 results in corresponding rotation of the bushing 222. As the result of the frictional clamp force applied to the blade 116 by the bushing 222 and spindle shaft 202, the cutting blade may also rotate.

However, when the cutting blade 116 strikes an object that may momentarily stop or slow the blade (e.g., a blade strike), the frictional clamp force on the blade may be overcome, i.e., the spindle shaft 202 may rotate relative to the blade. When this happens, however, little or no relative rotation generally occurs between the spindle shaft 202, the bushing 222, and the bolt 226 because of the engagement of the anti-rotate surfaces (splines 238 and 240). That is, the spindle shaft 202, the bushing 222, and the bolt 226 may continue to rotate together relative to the cutting blade 116. Because the bolt 226 may rotate with the spindle shaft 202, the bolt may avoid excessive tightening as may occur with other blade attachment configurations.

Although particular embodiments are shown and illustrated herein, other embodiments are certainly possible without departing from the scope of the invention. For example, other anti-rotate surfaces, e.g., a key and keyway, may be substituted for the splines 238 and 240 described herein. Further, the blade attachment configurations described and illustrated herein could be utilized with other mower configurations. For example, embodiments in accordance with the present invention could be incorporated into direct drive mowers, e.g., an engine crankshaft could be modified in accordance with the spindle shafts described and illustrated herein.

Exemplary embodiments of the present invention are described above. Those skilled in the art will recognize that many embodiments are possible within the scope of the invention. Other variations, modifications, and combinations of the various parts and assemblies can certainly be made and still fall within the scope of the invention. Thus, the invention is limited only by the following claims, and equivalents thereto.

What is claimed is:

1. A spindle assembly for supporting a cutting blade in relation to a lawn mower cutting deck, the assembly comprising:
a spindle shaft comprising a first end having an opening formed therein, the opening comprising a female anti-rotate surface; and
a tubular bushing comprising: a male anti-rotate surface for engaging the female anti-rotate surface such that little or no relative rotation occurs between the bushing and the spindle shaft; and a flange for holding the cutting blade against the first end of the spindle shaft.

2. The assembly of claim 1, wherein the female anti-rotate surface comprises a plurality of first splines located on an interior surface of the opening.

3. The assembly of claim 1, wherein the second anti-rotate surface comprises a plurality of second splines located on an exterior surface of the tubular bushing.

4. The assembly of claim 1, further comprising a fastener operable to secure the tubular bushing and the cutting blade to the spindle shaft.

5. A spindle assembly for supporting a cutting blade in relation to a lawn mower cutting deck, the assembly comprising:
a spindle shaft comprising a first end having an opening formed therein, the opening comprising a female anti-rotate surface; and
a tubular bushing comprising: a male anti-rotate surface operable to pass, with clearance, through a hole in the cutting blade and engage the female anti-rotate surface; and a flange, wherein the flange has an external dimension larger than the hole in the cutting blade.

6. The assembly of claim 5, wherein the female anti-rotate surface comprises a plurality of first splines located within the opening, and the male anti-rotate surface comprises a plurality of second splines located on the tubular bushing.

7. A lawn mower cutting deck comprising:
a deck housing defining a cutting chamber;
a cutting blade operable to rotate within the cutting chamber;
a spindle assembly for rotationally coupling the cutting blade to the housing, the spindle assembly comprising a spindle shaft having a first end proximate a first side of the cutting blade, wherein an opening is formed in the first end, the opening comprising a plurality of first splines therein; and
a bushing comprising a flange and a plurality of second splines, the second splines operable to engage the first splines such that little or no relative rotation occurs between the bushing and the spindle shaft;
wherein the cutting blade is located between the flange of the bushing and the first end of the spindle shaft.

8. The deck of claim 7, further comprising a fastener operable to secure the bushing and the cutting blade to the spindle shaft.

9. The deck of claim 7, wherein a portion of the bushing is operable to extend through a hole in the cutting blade.

10. The deck of claim 9, wherein the bushing is tubular.

11. A lawn mower cutting deck comprising:
a spindle assembly comprising: a spindle shaft having a first anti-rotate surface located within an opening formed at a first end of the spindle shaft; and a bushing comprising a second anti-rotate surface and a flange, wherein the second anti-rotate surface is operable to engage the first anti-rotate surface such that little or no relative rotation occurs between the bushing and the spindle shaft;
a cutting blade securable between the flange of the bushing and the first end of the spindle shaft; and
a housing for rotationally supporting the spindle assembly.

12. The deck of claim 11, wherein the first anti-rotate surface comprises one or more splines located on an interior surface of the opening, and the second anti-rotate surface comprises one or more mating splines located on an exterior surface of the bushing.

13. The deck of claim 11, wherein the flange comprises a clamp surface operable to seat against the cutting blade.

14. The deck of claim 11, wherein the cutting blade is frictionally secured by a clamp force generated between the flange and the first end of the spindle shaft.

15. A lawn mower cutting deck comprising:
a deck housing defining a cutting chamber;
a cutting blade operable to rotate within the cutting chamber;
a spindle shaft for rotationally attaching the cutting blade to the housing, the spindle shaft comprising: a first end having an opening formed therein, wherein the first end is operable to abut a first side of the cutting blade; and two or more first splines located on an interior surface of the opening;
a tubular bushing comprising: two or more second splines located on an exterior surface of the bushing, the second splines operable to pass, with clearance, through a hole in the cutting blade and engage the first splines; and a flanged portion operable to abut a second side of the cutting blade; and
a fastener for securing the bushing and the cutting blade to the spindle shaft.

16. The deck of claim 15, wherein the flanged portion comprises an outer diameter greater than a diameter of the hole in the cutting blade.

17. The deck of claim 15, wherein the opening in the spindle shaft further comprises a threaded portion for receiving the fastener.

18. A method for preventing over-tightening of a cutting blade attachment fastener relative to a lawn mower spindle shaft as a result of a blade strike, the method comprising:
inserting a flanged bushing through an opening in a cutting blade;
engaging a male anti-rotate surface of the flanged bushing with a female anti-rotate surface of the spindle shaft; and
fastening the flanged bushing to the spindle shaft with a bolt.

19. The method of claim 18, wherein fastening the flanged bushing comprises passing the bolt through the flanged bushing and the cutting blade and threadably engaging the bolt with a female thread formed in an opening of the spindle shaft.

20. The method of claim 18, wherein engaging the male anti-rotate surface with the female anti-rotate surface comprises engaging two or more external splines on the flanged bushing with two or more mating internal splines located within an opening in the spindle shaft.
